(19) United States
(12) Patent Application Publication
(10) Pub. No.: US 2006/0198125 A1
(43) Pub. Date: Sep. 7, 2006

(54) Light fixture with separable adaptive mount

(76) Inventor: James R. Malecek, Odessa, TX (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/071,412

(22) Filed: Mar. 2, 2005

(51) Int. Cl. F21S 8/00

(52) U.S. Cl. 362/147

(57) ABSTRACT

A lighting device adapted for mounting upon and within cabinets, walls, shelves and the like employing an adaptive mount with a removable portion. The device features an L-shaped bracket containing horizontal and vertical mounting surfaces communicating via a separable joint allowing disconnection of the two mounting surfaces. The light source is rotatable to illuminate surfaces at a plurality of different illumination angles. An optional toothbrush and cup holder may be engaged to the mount when engaged with a vertical support.

### FIELD OF THE INVENTION

The present invention relates to the general art of illumination devices. More specifically the device relates to the particular field of the illumination of bathroom sinks, cabinets, shelves, work areas, and other areas where a planar vertical or horizontal mounting surface is available and a rotatable adjustable light source with optional storage for dental hygiene implements would be desired.

### BACKGROUND OF THE INVENTION

Description of Related Art

The use of illumination devices such as area, compartment or general purpose task lights is well-known in the art. Most attention has been paid to illuminating the internal areas of such places as drawers, cabinets and cupboards, often with ingenious schemes for controlling activation through friction, photo-electronic effects or some combination. Generally, these devices may include a base, a switching device, and a light generating component emitting light in a hopefully desired direction. These devices may be used in situations where overall illumination of a room, an enclosure or an environment is unnecessary or unwanted. These devices may also be used where a particular object or area requires additional or more intense illumination than the surrounding area. Generic examples include bathroom mirrors or sink areas.

These devices may typically use incandescent or fluorescent light sources. As shall be noted, sources such as these suffer from a variety of problems. For example, incandescent lights may be fragile, have a relatively short life span, use a great deal of power and generate considerable heat that is capable of burning skin, upholstery and possibly creating a fire hazard. Incandescent lights are also susceptible to vibration and use a great deal of battery power, thus adversely affecting battery life. Further, current illumination devices such as book or task lights produce a light that is harsh on the user's eyes, with a very bright illuminated spot at the center of the illuminated area which fades in intensity towards the periphery of the illuminated area. In some cases, if adequate shielding or shading is not provided from the bulb, the light may be blinding to the user.

While traditional fluorescent lights may tend to be cooler than incandescent lights, they too are quite fragile and due to required ballasts and electronic components are typically too large and bulky for smaller applications. Additionally, some fluorescent lights may also have hot areas at their terminal ends and at their current inverters. Traditional fluorescent lights also tend to produce a flickering illumination and as they age this effect is magnified, causing both a distraction to the user and potential longer term negative effects on the user's vision. As shall be noted below, several less than optimal approaches have been employed in the past to achieve these goals and none has enjoyed complete success.

U.S. Pat. No. 5,032,957 (Canfield) describes an approach for an illuminating device for cabinets proposed to be attached within or external to a cabinet and that is switched on and off by responding to the action of the opening and closing of the cabinet door. The device is also capable of providing lighting in closed cabinets such as display cabinets with transparent fronts panels by use of a secondary and tertiary manually operated on/off and lockout switches. As described in the documentation, this device comes up short in that the light source is primarily intended for internal cabinet illumination, precluding the use of the external cabinet mirror. Additionally, in order to be used for external illumination, three separate switches are required to be set correctly, increasing user coordination requirements and complicating initial nocturnal use. Multiple switches also increase manufacturing design complexities and labor and materials costs. Finally, the light source is not intended to be variably directional with regard to either the surface mounting options or control of light direction.

Additionally, U.S. Pat. No. 5,246,285 (Redburn, et al.) teaches an invention, the object of which is to provide a self-contained lighting device for furniture, drawers, cabinets, toolboxes and the like which directs broad lighting into areas within such assemblages such as drawers, cabinets, and toolboxes as well as the area in front of the user without excess energy loss. These and other objects are achieved by the self-contained automatic enclosure lighting device of the invention comprising at least one light source directed into the enclosure, switch means associated with said light source, light sensor means to prohibit activation of said light source when a predetermined amount of light is detected in the area of said device regardless of the position of said switch means, timing means to deactivate said light sources after they have been activated for a predetermined period of time and batteries to power the lighting device. As can be seen, this device is primarily proposed to resolve the issue of providing illumination to internal spaces and is activated by the presence or absence of light as determined by a photo-electric sensor. Though it resolves the issue of cumbersome and potentially dangerous external wiring connections by utilizing batteries, the fact that it requires a change in illumination levels in order to be activated or deactivated reduces potential use in an externally mounted modality. Additionally, as described, no capability to modify the direction of the light source is provided as the direction is fixed.

U.S. Pat. No. 5,685,630 (Herman) teaches a similar intended device. A battery-operated automatically switched lighting device is provided for illumination of the interior of enclosures provided with doors, such as for closets, cupboards, cabinets, and the like. Instead of being light activated, this battery-powered switch actuator operates when the enclosure door is opened and closed. This method does not readily lend itself to external mounting nor was this the intent of the invention.

U.S. Pat. No. 6,666,563 (Brown) illustrates an illumination device that has a base portion, a neck portion attached to the base portion, a power source and an illumination panel that has an electroluminescent light source or a light guide that produces a diffuse light and is intended to be particularly suited for use as a book light or task light due to its uniform, diffuse light, and compact size. Though directable with regard to the light rays and potentially battery powered, this device is not intended for long term fixed use from a wall mounted or cabinet mounted position. Neither does this device provide a plurality of different mounting options for both a permanant horizontal or vertical mount.

As such, there is an unmet need for a counter illuminating light that is easily mounted to either a vertical or horizontal mounting surface. Such a device should best provide a means for adjustable illumination angle. Such a device should be user-safe by avoiding high voltage power from the electrical grid. Still further, such a device should have a mount that is easily adaptable to fit on either a narrow overhang or elongated vertical wall.

With respect to the above description, before explaining at least one preferred embodiment of the invention in detail, it is to be understood that the invention is not limited in its application to the details of construction and to the arrangement of the components and/or steps set forth in the following description or illustrated in the drawings. The various apparatus and methods of the invention herein described and disclosed are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other devices, methods and systems for carrying out the several purposes of the present disclosed device. It is important, therefore, that the objects and claims be regarded as including such equivalent construction and methodology insofar as they do not depart from the spirit and scope of the present invention.

Further objectives of this invention will be brought out in the following part of the specification, wherein detailed description is for the purpose of fully disclosing the invention without placing limitations thereon.

### SUMMARY OF THE INVENTION

The illumination device described in the particulars herein produces a brilliant area light for the user. It accomplishes this task by making use of the combination of an L shaped mounting bracket in a hinged engagement and providing a separable portion of the mounting bracket that may be removed depending on the mounting situation intended. Rotation is provided with means for a rotatable engagement of one portion of the bracket to the other which provides a mount for a water resistant illumination source.

The device may be attached to either a horizontal or a vertical mounting surface such as a bathroom cabinet or the wall holding up the cabinet employing means of attachment such as adhesive materials or other attaching components such as screws, hook and loop devices, nails and the like. The disclosed device may be for either portable or stationary installation. In various exemplary embodiments of this invention the illumination may be provided by means of illumination which in a preferred mode of the device employs an energy efficient LED. While the device is illustrated as rectangular in shape, it should be appreciated that the illumination source and shape according to this invention may be of any of a number of potential shapes, sizes or thicknesses.

It is an object of the present invention to provide a lighting device which is long lasting, economical, efficient and constructed and arranged to be adapted to a wide variety of existing horizontal or vertical implementations through utilization of a disconnectable joint. The lighting device of the present invention provides a lighting unit which can be added to existing planar surfaces or which could be incorporated into the original design and construction of the area to be illuminated.

It is another object of the invention to provide lighting structures having rotatable water resistant lighting modules comprising the bulb, energy source and switch. The module may be used for a variety of lighting needs and enables the lighting devices to be easily disassembled and serviced when necessary.

Yet another object to provide directable lighting structures adapted to direct light onto predetermined or selected areas.

A further another object to provide a construction arranged to contain the lighting module which permits the LED or battery, for example, to be easily replaced. Removable light modules could also be provided for use in emergency lighting situations when electrical power is disrupted, for example.

Yet another object of this invention is the provision of a lighting source for a counter or work area that provides an adaptive mount to either horizontal or vertical mounting surfaces which also provides adaptive angling of the light on the work area.

With respect to the above description, before explaining at least one preferred embodiment of the invention in detail, it is to be understood that the invention is not limited in its application to the details of construction and to the arrangement of the components or steps set forth in the following description or illustrated in the drawings, nor just to illumination devices. The apparatus and methods of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the objects and claims be regarded as including such equivalent construction and methodology insofar as they do not depart from the spirit and scope of the present invention.

Further objectives of this invention will be brought out in the following part of the specification, wherein detailed description is for the purpose of fully disclosing the invention without placing limitations thereon.

### BRIEF DESCRIPTION OF DRAWING FIGURES

FIG. 1 is a side view of an assembled unit in a wall mounted position with the light fixture facing upwards.

FIG. 2 is a side view of the unit showing the removable wall mount portion removed with the device in a cabinet mount.

FIG. 3 is a view of the optional removable tooth brush and cup holder engageable to the mount.

FIG. 4 is a side view of the device with the light positioned against the horizontal mount and facing downwards.

FIG. 5 is a perspective view of the device with the light rotated to face upwards.

### DETAILED DESCRIPTION OF PREFERRED EMBODIMENTS OF THE DISCLOSED DEVICE

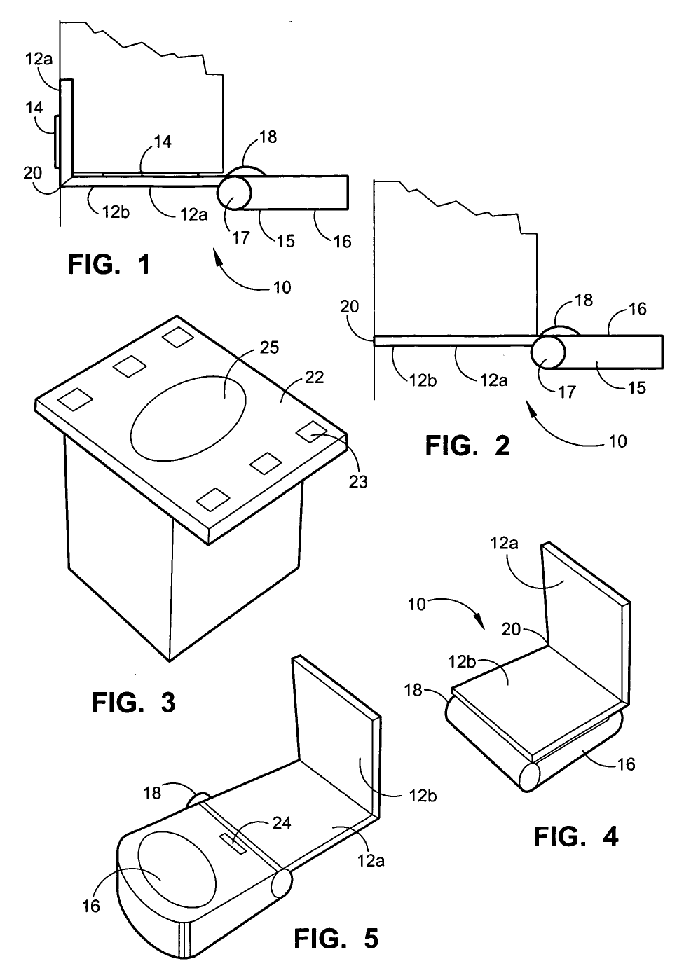

Referring now to the drawings FIGS. 1-5 described in the paragraphs below disclose currently preferred embodiments of the device herein disclosed. FIG. 1 is a side view of a preferred embodiment of an assembled fixture device 10 engaged upon a vertical wall. The mount 12 features a vertical mounting surface 12a engaged with a horizontal mounting surface 12b at the frangible interconnecting joint 20. The horizontal mounting surface 12a in the embodiment displayed positioned to receive the optional cup holder/tooth brush holder 24 which may be optionally engaged when the device 10 is mounted upon a vertical wall for support.

FIG. 2 depicts a side view of the assembled fixture device 10 mounted to and underside horizontal surface of a wall mounted cabinet. Mounted in this fashion, the removable wall mount 12a has been separated from the horizontal mount component 12a which has been attached to the undersurface of a cabinet using means of attachment to hold it in position. A means to render the wall mount 12a separable from the horizontal mount component 12a has been provided in the form of a separable joint 20 whereby the user may tear off or otherwise remove the wall mount 12a when not needed. Rotational engagement between the light housing 15 and the horizontal component 12a is provided by means of rotational engagement such as hinge 17.

As shown, the means for attachment of the horizontal mount component 12a to the cabinet is via an adhesive 14. Of course those skilled in the art will do doubt realize that one or a combination of means for attachment may be employed such as adhesive, screws, nails, brackets, or other means of attachment, and such is anticipated.

To aid the user in rotating the device from a stored position with the housing holding the light 16 rotated against the horizontal mount component 12a to a rotated or deployed position projecting therefrom, a handle 18 or other means for gripping the light portion of the device may be provided. Or the user can simply engage a side edge of the light housing 15 frictionally and cause it to rotate back and forth between the two positions.

Switching of the light 16 on to an illuminated state or off is provide by a means for switching the light on and off as currently shown as switch 24. The switch 24 shown is a depressable button type switch 24 which should be waterproof due to the environments the device 10 may face mounted over a sink and the like. Of course other switching means for activating the light 16 and connecting it to a low voltage power source such as batteries (not shown) can be used and such is anticipated. Another type of such a switching means could be a mercury type switch (not shown) that turns the light 16 off when the housing holding the light 16 is rotated to the stored position, and turns the light 16 on, when rotated to the deployed position a slight angle out of the stored position and away from the bottom surface of the cabinet or the horizontal mount 12a. This would allow for automatic activation of the light 16 by the user.

FIG. 3 depicts a perspective view of the optional removable tooth brush holder 22 component of the device 10. This component could be provided separately or provided with the rest of the device 10 in a kit form, giving the user the option of a vertical or horizontal mounting surface by simply disengaging the vertical component 12a as needed, and the subsequent engagement of the toothbrush holder 22 to the horizontal mount 12a on the device 10. The toothbrush holder 22 is adapted to engage upon the top surface of the horizontal mount component 12a when the device 10 is engaged in a wall mount. The tooth brush holder 22 would have one or both of apertures 23 adapted to engage toothbrushes and a cup aperture 25 adapted to frictionally engage the exterior of a cup. Adhesive or other means of attachment of the bottom surface of the tooth brush holder 22 to the horizontal mount component 12a would be provided and used during assembly of the device 10.

FIG. 4 depicts a perspective view of the adjustable fixture device 10 showing the horizontal component 12a and vertical component 12b as connected via the separable joint 20. The housing 15 for the light 16 is in a stored position with the light 16 facing downwards and the housing touching or immediately adjacent to the horizontal component 12a.

FIG. 5 is a perspective view of the device 10 showing the horizontal component 12a and vertical component 12b mounting connected via a means for removable engagement shown as the separable joint 20. This separable joint 20 renders the horizontal component 12b and vertical component 12a disengageable when desired. Such a means for separable attachment of the horizontal component 12 to the vertical component 12b can be accomplished by forming the mount 12 of plastic material and scoring the mount 12 at the joint 20 so it could be torn, cut, or broken away, to allow removal of the vertical component 12b from the horizontal component 12a. Of course other means for removable engagement of the vertical component 12b to the horizontal component such as a slidable engagement in a slot or snap together configuration can be employed and such are anticipated. However, a current preferred mode would be to render the two components separable with some type of perforation, detent, or scoring to allow for the separable joint to be formed during manufacture of the mount 12 in one piece. Also shown in this figure is the handle 18 in a rotated position with the light fixture 16 facing upwards. Shown also is the waterproof light switch 24 which as shown is mechanically activated but can also be a conventional automatically activated switch.

Although the invention herein has been described with respect to particular embodiments thereof, it should be realized that various changes and modifications may be made therein without departing from the spirit and scope of the invention. While the invention as shown in the drawings and described in detail herein discloses arrangements of elements of particular construction and configuration for illustrating preferred embodiments of structure and method of operation of the present invention, it is to be understood, however, that elements of different construction and configuration and other arrangements thereof, other than those illustrated and described, may be employed in accordance with the spirit of this invention. Any and all such changes, alternations and modifications, as would occur to those skilled in the art, are considered to be within the scope of this invention as broadly defined in the appended claims.

Further, the purpose of the attached abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

What is claimed is:

1. A light fixture adapted for wall or cabinet mounting comprising:
a mount;
said mount having a horizontal component having an upper surface, a lower surface, and engagement end, and a distal end opposite said engagement end;
said mount having and a vertical component having a back surface and a front surface;
means for separable engagement of said engagement end of horizontal component in a substantially perpendicular attachment to said vertical component;
a housing having an upper surface and a lower surface;
means for illumination engaged with said lower surface of said housing;
means for engagement of said housing to said horizontal component with said upper surface of said housing adjacent to said lower surface of said horizontal component;
means of attachment of said vertical component to a vertically disposed surface mount;
means of attachment of said horizontal surface to a horizontally disposed surface mount; and
whereby said mount may be attached to either of said vertically disposed surface when said horizontal component is engaged to said vertical component or to said horizontally disposed surface once said vertical component is separated from said horizontal component.

2. The light fixture of claim 1 wherein said means for engagement of said housing to said horizontal component comprises:
means for rotational engagement of said housing to said horizontal component said means for rotational engagement providing rotation of said housing between a stored position with said upper surface of said housing adjacent to and substantially parallel with, said horizontal component, to a deployed position wherein said upper surface of said housing is angled away from horizontal component.

3. The light fixture of claim 2 wherein said means for rotational engagement comprises:
a hinged engagement between said housing and said distal end of said horizontal component.

4. The light fixture of claim 3 wherein said housing in said deployed position allows for projection of said lower surface of said housing past said distal end of said horizontal component.

5. The light fixture of claim 1 additionally comprising:
an elongated tooth brush holder having a top surface and a bottom surface connected by sidewalls;
said top surface adapted to engage at least one toothbrush; and
means for attachment of said bottom surface of said and toothbrush holder to said upper surface of said horizontal component.

6. The light fixture of claim 2 additionally comprising:
an elongated tooth brush holder having a top surface and a bottom surface connected by sidewalls;
said top surface adapted to engage at least one toothbrush; and
means for attachment of said bottom surface of said and toothbrush holder to said upper surface of said horizontal component.

7. The light fixture of claim 3 additionally comprising:
an elongated tooth brush holder having a top surface and a bottom surface connected by sidewalls;
said top surface adapted to engage at least one toothbrush; and
means for attachment of said bottom surface of said and toothbrush holder to said upper surface of said horizontal component.

8. The light fixture of claim 4 additionally comprising:
an elongated tooth brush holder having a top surface and a bottom surface connected by sidewalls;
said top surface adapted to engage at least one toothbrush; and
means for attachment of said bottom surface of said and toothbrush holder to said upper surface of said horizontal component.

9. The light fixture of claim 1 wherein said means for illumination comprises:
a electrical light;
a low voltage power source; and
a means for switching said electrical light between an illuminated state engaged with said power source and a static state disengaged from said power source.

10. The light fixture of claim 2 wherein said means for illumination comprises:
a electrical light;
a low voltage power source; and
a means for switching said electrical light between an illuminated state engaged with said power source and a static state disengaged from said power source.

11. The light fixture of claim 3 wherein said means for illumination comprises:
a electrical light;
a low voltage power source; and
a means for switching said electrical light between an illuminated state engaged with said power source and a static state disengaged from said power source.

12. The light fixture of claim 9 wherein said means switching comprises:
a mechanically activateable electric switch.

13. The light fixture of claim 10 wherein said means switching comprises:
a mechanically activateable electric switch.

14. The light fixture of claim 11 wherein said means switching comprises:
a mechanically activateable electric switch.

15. The light fixture of claim 9 wherein said means switching comprises:
an automatic switch changing said electrical light from said static state when said housing is in said stored position to said activated state when said housing is in said deployed position.

16. The light fixture of claim 10 wherein said means switching comprises:
an automatic switch changing said electrical light from said static state when said housing is in said stored position to said activated state when said housing is in said deployed position.

17. The light fixture of claim 11 wherein said means switching comprises:
an automatic switch changing said electrical light from said static state when said housing is in said stored position to said activated state when said housing is in said deployed position.

18. The light fixture of claim 1 wherein said
means for separable engagement of said engagement end of horizontal component in a substantially perpendicular attachment to said vertical component is a score in the surface of said mount at an engagement point between said horizontal component and said vertical component.

19. The light fixture of claim 2 wherein said means for separable engagement of said engagement end of horizontal component in a substantially perpendicular attachment to said vertical component is a score in the surface of said mount at an engagement point between said horizontal component and said vertical component.

20. The light fixture of claim 5 wherein said means for separable engagement of said engagement end of horizontal component in a substantially perpendicular attachment to said vertical component is a score in the surface of said mount at an engagement point between said horizontal component and said vertical component.
